(19) United States
(12) Patent Application Publication
(10) Pub. No.: US 2006/0225043 A1
(43) Pub. Date: Oct. 5, 2006

(54) Debugging device

(75) Inventors: Shigeyoshi Oda, Sakai-shi (JP); Tsutomu Mikami, Kyoto-shi (JP); Takeshi Matsumoto, Otokuni-gun (JP); Kohsaku Shibata, Takatsuki-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/374,064

(22) Filed: Mar. 14, 2006

(30) Foreign Application Priority Data
Mar. 15, 2005 (JP) 2005-072486

(51) Int. Cl. G06F 9/44

(52) U.S. Cl. 717/124

(57) ABSTRACT

A debugging device according to the present invention comprises a host communication section for transmitting and receiving data to and from a host computer, a target communication section for transmitting and receiving data to and from a target CPU as an object to be debugged, an external storage medium for storing a unique discrimination code for identifying the storage medium and an encrypted license information, and a control section for decoding the license information using a predetermined secret key and judging whether or not the license information is valid using the discrimination code.

### FIELD OF THE INVENTION

The present invention relates to a technology for license management of a debugging device in a debugging system capable of observing a program execution state of CPU (central processing unit) from an external device.

### DESCRIPTION OF THE INVENTION

Conventionally, device numbers respectively unique to a host computer and a debugging device are used in license management in a debugging system (for example, see No. US2002-0194477 A1 (see FIG. 1).

Hereinafter, the conventional license management in the debugging system is described referring to the drawings.

FIG. 32 is a block diagram illustrating a constitution of a conventional debugging system. The conventional debugging system comprises a host computer 50, an input unit 54 such as a keyboard and a mouse, a display unit 55 for displaying a processing result of the host computer 50, a debugging device B, and a target CPU 60. A connection form between the host computer 50 and the debugging device B employs a general host interface such as USB (universal serial bus), and they are connected to each other by way of a cable. A connection form between the debugging device B and the target CPU 60 employs, for example, the JTAG interface defined by IEEE1149.1, and they are connected to each other by way of a cable. The host computer 50 comprises a debugger 51 and a license formation file 53. The debugger 51 is a software operated on the host computer 50, and a license judging section 52 is included in a processing executed by the debugger 51. The license judging section 52 references the license information file 53 to thereby judge whether or not a license of the debugger is valid. The license information file 53 will be described later.

The debugger 51 interprets a debug command inputted from the input unit 54 and outputs a debug command D11 to the debugging device B. The debugging device B converts the received debug command D11 into a signal that can be transmitted to the target CPU 60, and outputs a target command D12 to the target CPU 60. The target CPU 60 executes any necessary processing in accordance with the received target command D12, and outputs a target data D13 to the debugging device B. The debugging device B, which has received the target data D13, outputs a debug data D14 to the host computer 50. Then, the debugger 51 receives the debug information of the target CPU 60. The debugger 51 executes any necessary processing based on the debug information, and displays a relevant result on the display unit 55. The license of the debugger 51 is processed in the license judging section 52 when the debugger 51 is activated. The license judging process will be described later.

FIG. 33 is a block diagram illustrating a constitution of the debugging device B. The debugging device B comprises a host communication section 51 and a target communication section 42. The host communication section 41 transmits and receives data to and from the debugger 51 on the host computer 50. The target communication section 42 transmits and receives data to and from the target CPU 60. The host communication section 41, upon the reception of the debug command D11 from the debugger 51, outputs an internal signal S21 to the target communication section 42. The target communication section 42, to which the internal signal S21 is inputted, converts the inputted internal signal S21 into a JTAG command and outputs the target command D12 to the target CPU 60. The target communication section 42 receives the target data D13 from the target CPU 60 and outputs an internal signal S22 to the host communication section 41. The host communication section 41, to which the internal signal S22 is inputted, outputs the debug data D14 to the debugger 51.

The debugging device B transmits and receives signals to and from the host computer 50 and the target CPU 60, but is not responsible for the license management. The license judging section 52 in the host computer 50 is in charge of the license management.

As shown in FIG. 34, the license information file 53 is stored in such a text file format as “TARGET_TYPE=MN10XXXX” which is a product type information of the target CPU 60, “GOODTHRU=2005/12/31” which is a license validity term, “USER=TARO_MATSUSHITA” which is a user name, and “PASSWORD=********” which is a password.

The license judging process by the debugger 51 is described referring to a flow chart of FIG. 35.

The process shifts to Step p1 to start when a user requests the activation of the debugger.

In Step p2, the license information file 53 is read.

In Step p3, it is checked whether or not the read license information file 53 is valid, and thereafter, it is checked if the license is currently valid. The process advances to Step p4 when the license is valid, while advancing to Step p5 when invalid.

In the Step p4, the debugger 51 is activated.

In the Step p5, a license error is displayed on the display unit 55. FIG. 36 shows the display of the license error. When the license judging process fails, the software of the debugger 51 displays an error message 55a on the display unit 55 to thereby control the activation of the debugger 51.

As described, on the host computer 50, the validity of the license information is judged from the license information file 53. Then, the debugger 51 is activated when the license information is valid, while the process is interrupted when invalid so that the activation of the debugger 51 is controlled. The license management of the debugger 51 is thus performed.

The conventional technology described above, wherein the license information management file 53 used for the license management of the debugger is inside the host computer 50 comprising the input unit (keyboard and mouse) 54, included such a risk that the debugger could be easily illegally used when the information in the file was falsified or illegally copied via the input unit 54.

### SUMMARY OF THE INVENTION

Therefore, a main object of the present invention is to provide a debugging device capable of performing a high-security license management wherein a license information of a debugger cannot be easily falsified and illegally used.

A debugging device according to the present invention comprises a host communication section for transmitting and receiving data to and from a host computer, a target communication section for transmitting and receiving data to and from a target CPU as an object to be debugged, an external storage medium for storing a unique discrimination code for identifying the storage medium and an encrypted license information, and a control section for decoding the license information using a predetermined secret key and judging whether or not the license information is valid using the discrimination code.

According to the foregoing constitution, the encrypted license information is stored in the external storage medium, and the secret key is used to decode the license information in the debugging device in which an input device is not provided. Such a constitution makes it difficult for a third party to decode the license information. As a result, the license management of the debugger can be performed at a high security level.

The debugging device constituted as above effectively further comprises a time management section for managing time and date. The debugging device thus constituted can manage the date and time in the time management section provided therein to thereby manage a license validity term at a high security level.

The debugging device constituted as above effectively further comprises a network section for transmitting and receiving data to and from an external network line. The debugging device thus constituted can transmit and receive the data to and from the external network line in the network section provided therein to thereby renew the license at a high security level.

In the foregoing constitution, the target CPU comprises a unique discrimination code for identifying a product type of the target. Thereby, the license management of the debugger consistent with the target CPU can be performed.

The followings are preferable modes of the license information in the foregoing constitution.

According to a first mode, the license information includes a license validity term information indicating a term during which the debugger and the debugging device can be used. Thereby, the license validity term information indicating the term during which the debugger and the debugging device are usable can be managed.

According to a second mode, the license information includes an activation-permit frequency information indicating number of times when the activation of the debugger is permitted. Thereby, the number of times when the activation of the debugger is permitted can be managed.

According to a third mode, the license information includes a command-use setting information indicating presence or absence of limitations in using a debug command. Thereby, the presence or absence of the limitations in using the debug command of the debugger can be managed.

According to a fourth mode, the license information includes a command-use permit information indicating a debug command which is permitted to be used. Thereby, the debug command of the debugger permitted to be used can be managed.

According to a fifth mode, the license information includes a command-use nonpermit information indicating a debug command which is not permitted to be used. Thereby, the debug command of the debugger not permitted to be used can be managed.

According to a sixth mode, the license information include a corresponding product type information indicating a product type of the CPU that can be debugged by the debugger. Thereby, the product type of the CPU that can be debugged by the debugger can be managed.

According to a seventh mode, the license information includes a unique user ID information for identifying a user. Thereby, the unique user ID that can be used to identify the user can be managed.

According to an eighth mode, the license information includes a unique host-use permit information for identifying a host computer permitted to be connected to the debugging device. Thereby, the host computer permitted to be connected to the debugging device can be managed.

According to a ninth mode, the license information includes a command-execution frequency information indicating number of times when a debug command can be executed. Thereby, the number of times when the debug command of the debugger is permitted to be used can be managed.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating a constitution of a debugging system according to a first preferred embodiment of the present invention.

FIG. 2 is a block diagram illustrating a constitution of a debugging device according to the first preferred embodiment.

FIG. 3 shows a structure of an external storage medium discrimination code according to the first preferred embodiment.

FIG. 4 shows a structure of a secret key according to the first preferred embodiment.

FIG. 5 shows a structure of a target ID information according to the first preferred embodiment.

FIG. 6 shows a structure of an encrypted license information according to the first preferred embodiment.

FIG. 7 shows a structure of a license data according to the first preferred embodiment.

FIG. 8 shows a structure of a license data including a validity term information according to the first preferred embodiment.

FIG. 9 shows a structure of a license data including an activation-permit frequency information according to the first preferred embodiment.

FIG. 10 shows a structure of a license data including a command-use setting information according to the first preferred embodiment.

FIG. 11 shows a structure of a license data including a command-use permit information according to the first preferred embodiment.

FIG. 12 shows a structure of a license data including a command-use nonpermit information according to the first preferred embodiment.

FIG. 13 shows a structure of a license data including a corresponding product type information according to the first preferred embodiment.

FIG. 14 shows a structure of a license data including an external storage medium discrimination code information according to the first preferred embodiment.

FIG. 15 shows a structure of a license data including a user information according to the first preferred embodiment.

FIG. 16 shows a structure of a license data including a host-use permit information according to the first preferred embodiment.

FIG. 17 shows a structure of a license data including a command-execution frequency information according to the first preferred embodiment.

FIG. 18 is a (first) flow chart of a license information judging process according to the first preferred embodiment.

FIG. 19 is a (second) flow chart of the license information judging process according to the first preferred embodiment.

FIG. 20 shows a window display when the user information is inputted according to the first preferred embodiment.

FIG. 21 shows an error display when a license is invalid according to the first preferred embodiment.

FIG. 22 is a flow chart of the license information judging process when a debug command is processed according to the first preferred embodiment.

FIG. 23 is a block diagram illustrating a constitution of a debugging device according to a second preferred embodiment of the present invention.

FIG. 24 is a (first) flow chart of a license information judging process according to the second preferred embodiment.

FIG. 25 is a (second) flow chart of the license information judging process according to the second preferred embodiment.

FIG. 26 is a block diagram illustrating a constitution of a debugging system according to a third preferred embodiment of the present invention.

FIG. 27 is a block diagram illustrating a constitution of a debugging device according to the third preferred embodiment.

FIG. 28 is a flow chart of a license information renewing process in the debugging device according to the third preferred embodiment.

FIG. 29 shows a window display when the license information is renewed according to the third preferred embodiment.

FIG. 30 shows a message display when the license renewal is failed according to the third preferred embodiment.

FIG. 31 shows a message display when the license renewal is completed according to the third preferred embodiment.

FIG. 32 is a block diagram illustrating a constitution of a debugging system according to a conventional technology.

FIG. 33 is a block diagram illustrating a constitution of a debugging device according to the conventional technology.

FIG. 34 shows a license information file according to the conventional technology.

FIG. 35 is a flow chart of a license judging process in the debugging system according to the conventional technology.

FIG. 36 shows an error display when the license is invalid in the debugging system according to the conventional technology.

### DETAILED DESCRIPTION OF THE INVENTION

Hereinafter, preferred embodiments of a debugging system including a debugging device according to the present invention are described in detail referring to the drawings.

### First Preferred Embodiment

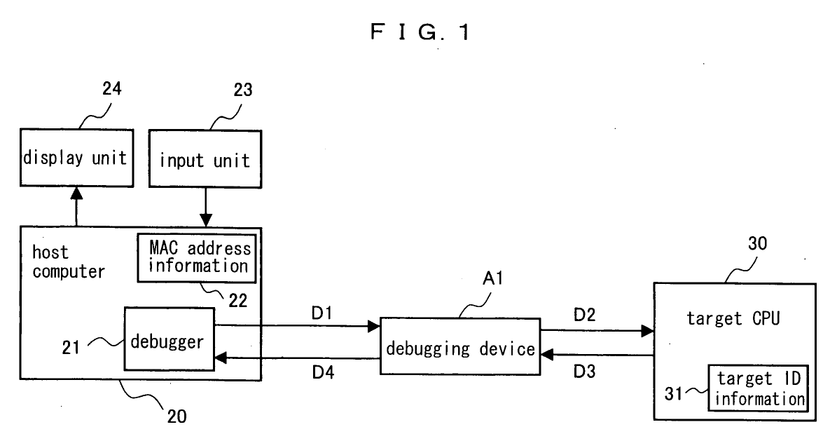

A first preferred embodiment of the present invention is described referring to FIGS. 1 through 22.

FIG. 1 is a block diagram illustrating a constitution of a debugging system according to the first preferred embodiment. The debugging system comprises a host computer 20, an input unit 23, a display unit 24, a debugging device A1, and a target CPU 30. The host computer 20 comprises a debugger 21 as a software operated on the host computer 20 and a MAC address information 22 as a unique discrimination code for identifying the host computer 20. The debugger 21 interprets a command inputted from the input unit 23, and outputs a debug command D1 to the debugging device A1. The debugging device A1, which has received the debug command D1, executes a predetermined processing thereto and outputs a target command D2 to the target CPU 30. The target CPU 30, which has received the target command D2, executes a predetermined processing thereto and outputs a target data D3 to the debugging device A1. The target CPU 30 includes a unique target ID information 31 for identifying a product type of the target. The debugging device A1 receives the target data D3 and correspondingly executes a predetermined processing thereto, and outputs a debug data D4 to the debugger 21.

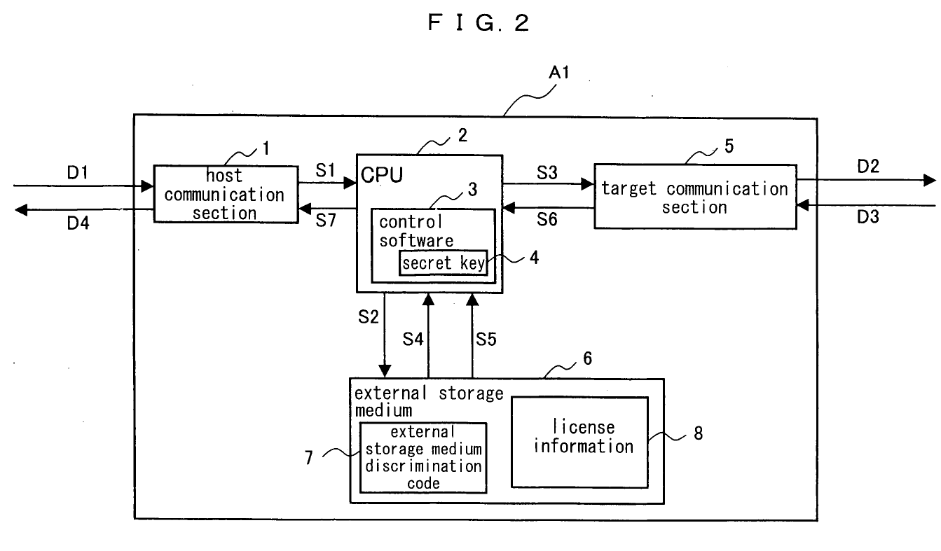

FIG. 2 is a block diagram illustrating a constitution of the debugging device A1. The debugging device A1 comprises a host communication section 1, a CPU 2, a target communication section 5, and an external storage medium 6. The CPU 2 comprises a control software 3 and a secret key 4. The external storage medium 6 comprises an external storage medium discrimination code 7 and an encrypted license information 8.

The host communication section 1 outputs an internal signal S1 to the CPU 2 when the debug command D1 is received from the debugger 21. The CPU 2, to which the internal signal S1 is inputted, executes the control software 3 previously stored therein, outputs an internal signal S2 to the external storage medium 6, and outputs an internal signal S3 to the target communication section 5. The external storage medium 6, to which the internal signal S2 from the CPU 2 is inputted, executes a predetermined processing thereto and outputs an internal signal S4 to the CPU 2. When the external storage medium 6 is inserted or extracted with respect to the debugging device A1, the external storage medium 6 generates an internal signal S5 and transmits it to the CPU 2 as an interruption signal. The target communication section 5 converts the internal signal S3 inputted from the CPU 2 into a JTAG command, and outputs the target command D2 to the target CPU 30. The target communication section 5 further outputs an internal signal S6 to the CPU 2 when the target data D3 from the target CPU 30 is received. The CPU 2 executes a predetermined processing corresponding to each of the inputted internal signals S4, S5 and S6 thereto, and outputs an internal signal S7 to the host communication section 1. The host communication section 1, to which the internal signal S7 from the CPU 2 is inputted, outputs the debug data D4 to the debugger 21. The debugger 21 outputs the debug command D1 to the debugging device A1 and receives the debug data D4 from the debugging device A1 to thereby obtain an internal information of the target CPU 30 and display the obtained information on the display unit 24. Thereby, the debug information can be displayed to a user of the debugger so that the software operated on the target CPU 30 can be debugged.

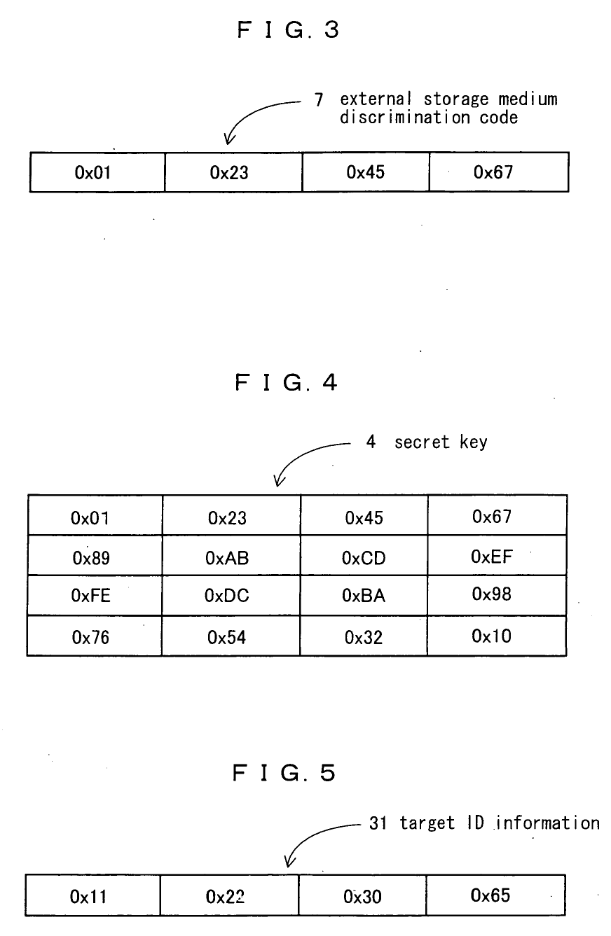

FIG. 3 shows a structure of the external storage medium discrimination code 7. The external storage medium discrimination code 7 is a unique discrimination code for identifying the external storage medium 6 having the value of 32 bits (4 bytes) and denotes a product number information of the external storage medium 6. In FIG. 3, a value “0x01234567” is stored as the external storage medium discrimination code 7.

FIG. 4 shows a structure of the secret key 4 incorporated in the control software 3. The secret key 4 is used to decode the encrypted license information 8 stored in the external storage medium 6 and has the value of 128 bits (16 bytes). The license information 8 is decoded in such a manner that an exclusive OR thereof with respect to the secret key 4 is obtained. In FIG. 4, a value “0x0123456789ABCDEFFEDCBA9876543210” is stored as the secret key. The secret key 4 has the 128-bit length in order to make it practically impossible to decode the key because it takes an astronomical length of time to decode the key of the length in a round-robin fashion.

FIG. 5 shows a structure of the target ID information 31 in the target CPU 30 shown in FIG. 1. In FIG. 5, a 4-byte numeral value, “0x11”, “0x22”, “0x30” and “0x65”, is shown.

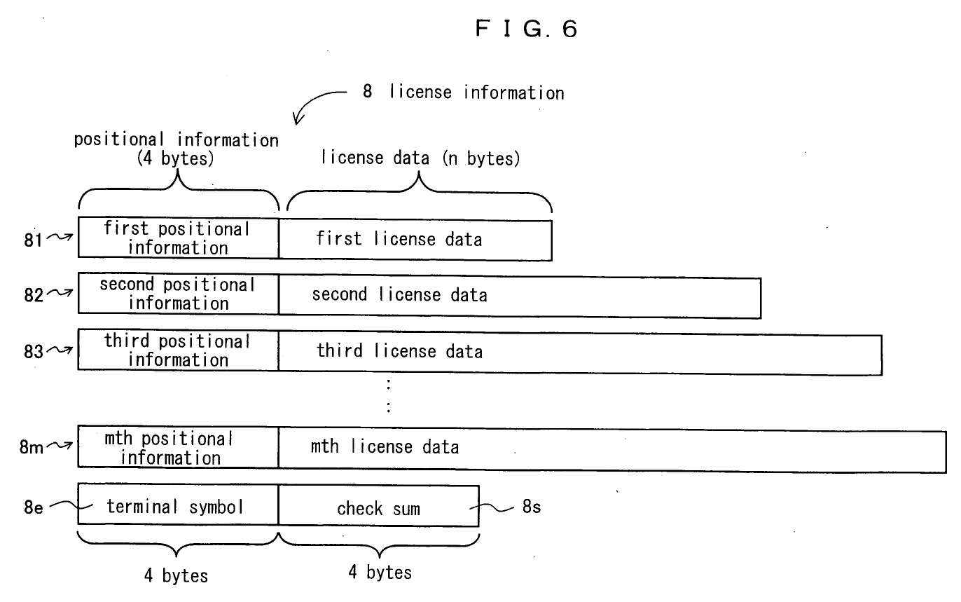

FIG. 6 shows a structure of the encrypted license information 8. The license information 8 has a structure comprising a plurality of sets, in each of which a positional information of 4 bytes and a license data of n bytes are paired, in order to correspond to a variable-length information and a variable number information. The positional information whose value is “0” is denoted by a terminal symbol Se, which indicates an end of the information. Subsequent to the terminal symbol Se, the sum of these informations is stored as a check sum Ss in a 4-byte numeral value.

A first license information 81 comprises a first positional information and a first license data. A second license information 82 comprises a second positional information and a second license data. A third license information 83 comprises a third positional information and a third license data. An mth license information 8m comprises an mth positional information and an mth license data. Each positional information has 4 bytes, and each license data has n bytes. A reference 8e denotes the terminal of 4 bytes, and a reference 8s denotes the check sum of 4 bytes.

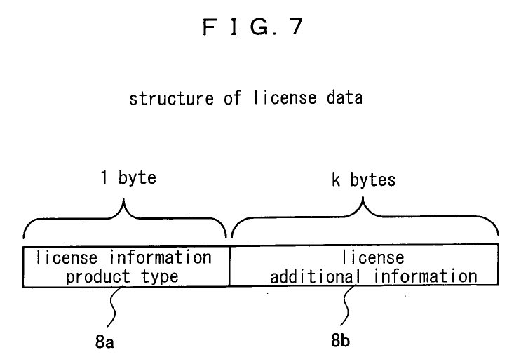

As shown in FIG. 7, the license data comprises a license information product type 8a of 1 byte and a license additional information 8b of k bytes as shown in FIG. 7. The license information product type 8a includes a validity term information, activation-permit frequency information, command-use setting information, command-use nonpermit information, corresponding product type information, external storage medium discrimination code information, user information and host-use permit information, and each of the foregoing informations includes an additional information.

The additional information of the validity term information includes a validity term “year/month/date”. The additional information of the activation-permit frequency includes a remaining number of times when the activation is permitted. The additional information of the command-use setting includes a flag information indicating the command use permit (default denotes the command use permit) and the command-use nonpermit (default denotes the command-use nonpermit). The additional information of the command use permit includes a command name and an option name to be permitted. The additional information of the command use nonpermit includes a command name and an option name not to be permitted. The additional information of the corresponding product type information includes a corresponding product type name. The additional information of the external storage medium discrimination code information includes a discrimination code of the external storage medium. The additional information of the user information includes a user name and a password. The additional information of the host-use permit information includes a MAC address of the host computer permitted to be used.

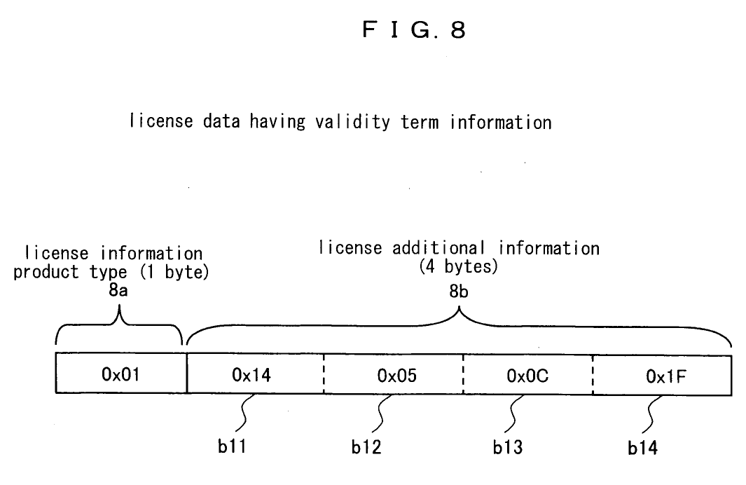

A structure of the license data is described referring FIGS. 8 through 17.

FIG. 8 shows a structure of the license data including the validity term information. The license information product type 8a of 1 byte representing the validity term information has the fixed value of “0x01”. The license additional information Bb of 4 bytes comprises b11, b12, b13 and b14 segmented per byte. b11 represents upper two digits of year” of the validity term, b12 represents “lower two digits of year” of the validity term, b13 represents “month” of the validity term, and d14 represents “day” of the validity term. b11 is “0x14”, b12 is “0x05”, b13 is “0x0C”, and b14 is “0x1F, based on which the validity terms is “Dec. 31, 2005”.

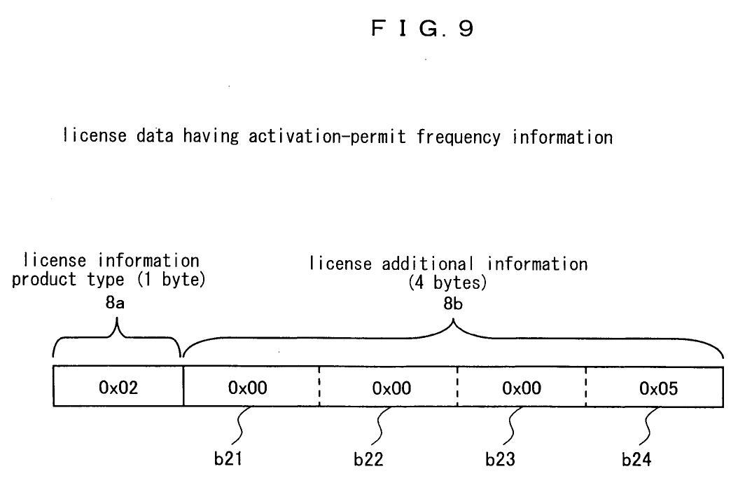

FIG. 9 shows a structure of the license data including the activation-permit frequency information. The license information product type 8a of 1 byte representing the activation-permit frequency information has the fixed value of “0x02”. The license additional information 8b of 4 bytes comprises b2, b22, b23 and b24 segmented per byte which represent the number of times when the activation is permitted. b21 is “0x00”, b22 is “0x00”, b23 is “0x00”, and b24 is “0x05”, based on which the number of times when the activation is permitted is “5”. The number of times when the activation is permitted is reduced by 1 every time when the activation is requested by the software on the debugger 21 with respect to the debugging device A1. When the information has reached “0”, the debugger is no longer activated.

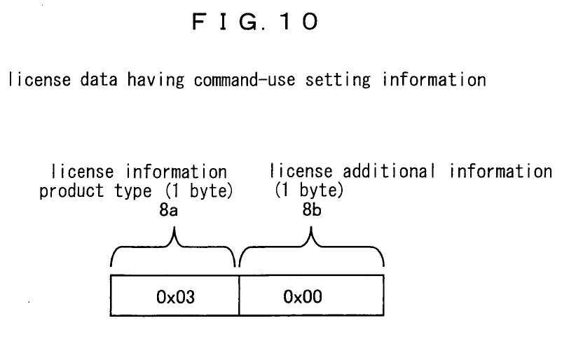

FIG. 10 shows a structure of the license data including the command-use setting information. The license information product type 8a of 1 byte representing the command-use setting information has the fixed value of “0x03”. The license additional information 8b of 1 byte represents the command-use setting, wherein the default is set as the command use permit in the case of “0x00”, and the default is set as the command use non permit in the case of “0xFF”. In the example in FIG. 10 showing “0x00”, the default is set as the command use permit.

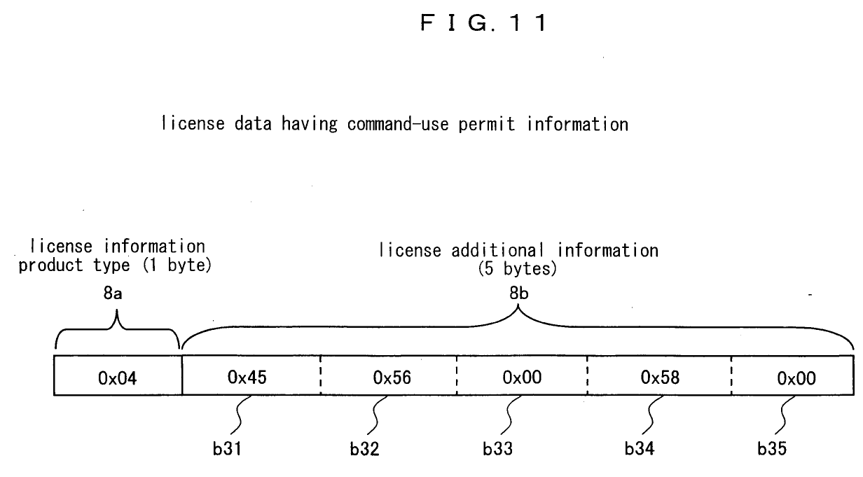

FIG. 11 shows a structure of the license data including the command-use permit information. The license information product type 8a of 1 byte representing the command-use permit information has the fixed value of “0x04”. The license additional information 8b of 5 bytes comprises b31, b32, b33, b34 and b35 segmented per byte, in each of which a code “0x00” denoting the end of an ASCII character and command name is stored. In the example shown in the drawing, b31 is “0x45” representing a character string “E”, b32 is “0x56” representing a character string “V”, b33 is “0x00” representing an end of a character string, b34 is “0x58” representing a character string “X”, and b35 is “0x00” representing an end of the character string, which denotes that an X option of an EV command is permitted to be used. In the foregoing description, a single command of the EV command is permitted. However, in the case of permitting the use of a plurality of commands, the command-use permit can be set when the license information product type 8a and the license additional information 8b are further added.

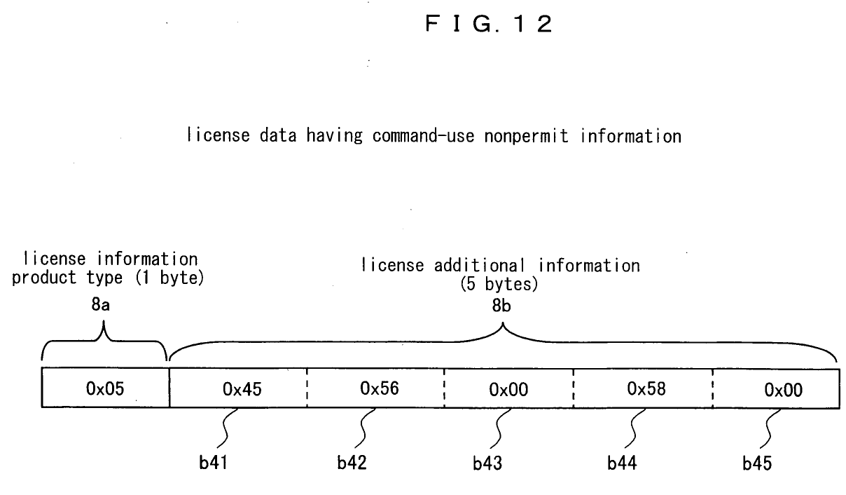

FIG. 12 shows a structure of the license data including the command-use nonpermit information. The license information product type 8a of 1 byte representing the command-use nonpermit information has the fixed value of “0x05”. The license additional information Bb of 5 bytes comprises b41, b42, b43, b44 and b45 segmented per byte, in each of which the code “0x00” denoting the end of the ASCII character and command name is stored. In the example shown in the drawing, b41 is “0x45” representing the character string “E”, b42 is “0x56” representing the character string “V”, b43 is “0x00” representing the end of the character string, b44 is “0x58” representing the character string “X”, and b45 is “0x00” representing the end of the character string, which denotes the X option of the EV command is not permitted to be used. In the foregoing description, the use of a single command of the EV command is not permitted. However, in the case of not permitting the use of a plurality of commands, the command-use nonpermit can be set when the license information product type 8a and the license additional information 8b are further added.

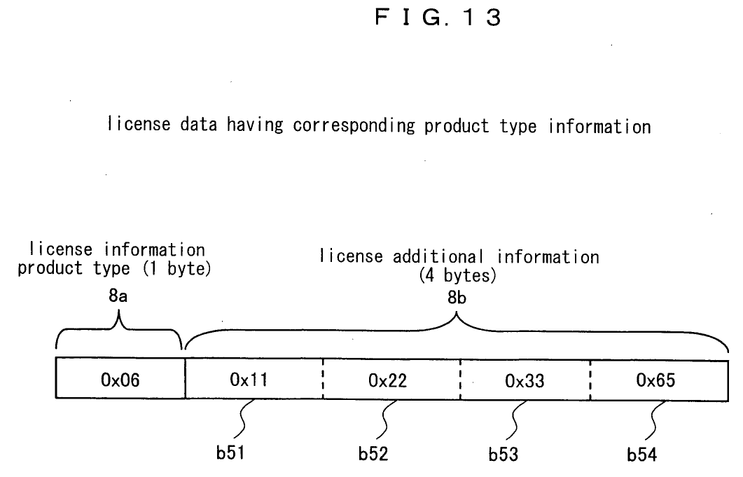

FIG. 13 shows a structure of the license data including the corresponding product type information. The license information product type 8a of 1 byte representing the corresponding product type information has the fixed value of “0x06”. The license additional information 8b of 4 bytes comprising b51, b52, b53 and b54 represents a discrimination number of the corresponding product type information having the license (the discrimination number is, for example, an ID code of JTAG defined by IEEE1149.1) In the example shown in the drawing, “0x11223365” is set as the corresponding product type information having the license.

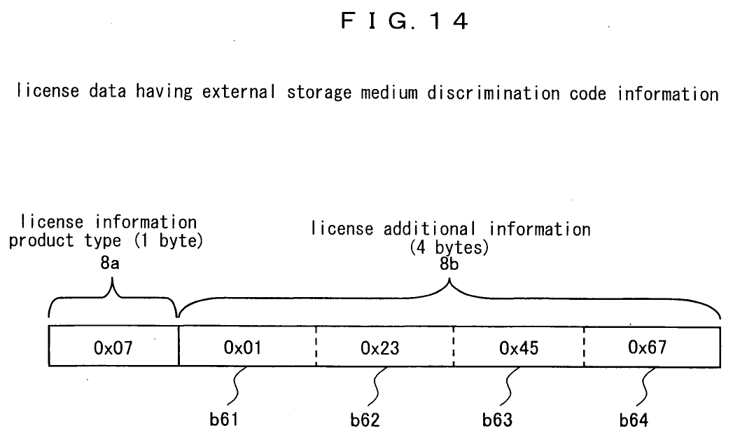

FIG. 14 shows a structure of the license data including the external storage medium discrimination code information. The license information product type 8a of 1 byte representing the external storage medium discrimination code information has the fixed value of “0x07”. The license additional information 8b of 4 bytes comprising b61, b62, b63 and b64 stores therein a unique discrimination code for identifying the external storage medium, an example of which is a product number of the external storage medium. In the example shown in the drawing, “0x1234567” is set as the discrimination code.

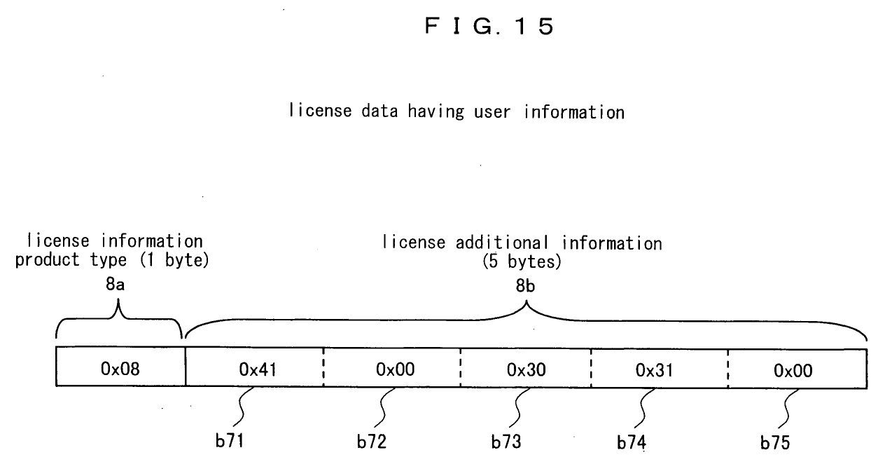

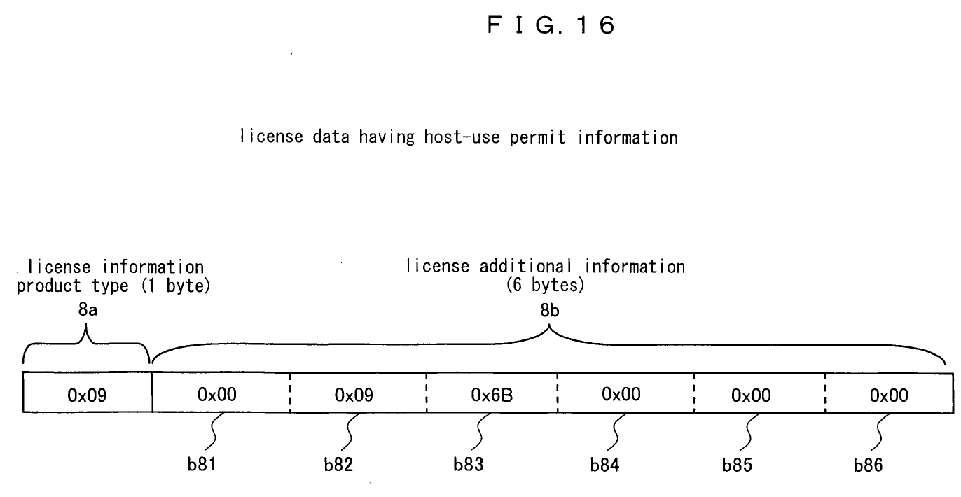

FIG. 15 shows a structure of the license data including the user information. The license information product type 8a of 1 byte representing the user information has the fixed value of “0x08”. The license additional information 8b of 5 bytes comprises b71, b72, b73, b74 and b75 segmented per byte, in each of which the code “0x00” denoting the end of the ASCII character and command name is stored. In the example shown in the drawing, b71 is “0x41” representing a character string “A”, b72 is “0x00” representing the end of the character string, b73 is “0x30” representing a character string “0”, b74 is “0x31” representing a character string “1, and b75 is “0x00” representing the end of the character string. Therefore, the information in which the user name is “A” and the password is “01” is stored.

FIG. 16 shows a structure of the license data including the host-use permit information. The license information product type 8a of 1 byte representing the host-use permit information has the fixed value of “0x00”. The license additional information 8b of 6 bytes comprising b81, b82, b83, b84, b85 and b86 stores therein a MAC address value “00096B000000” of the host computer which permits the use of the debugging device A1. Therefore, any host computer which does not have the foregoing MAC address value is not permitted to be connected.

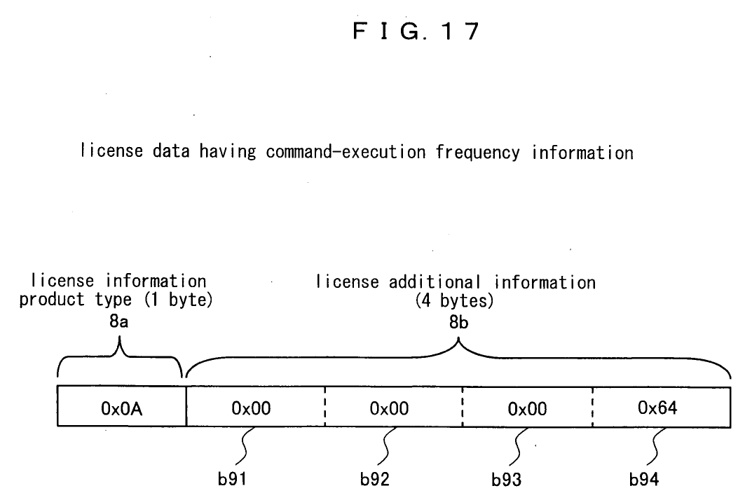

FIG. 17 show a structure of the license data including the command-execution frequency information. The license information product type 8a of 1 byte representing the command-execution frequency information has the fixed value of “0x0A”. The license additional information 8b of 4 bytes comprising b91, b92, b93 and b94 represents the number of times when the executable command is executed. In the example shown in the drawing, “0x00000064” is shown, which denotes that the command can be executed 100 times. The debugging device A1 reduces the command-execution frequency information by “1” every time when the request for the command execution from the debugger is received. When the command-execution frequency has reached “0”, the debugging device A1 controls the execution of the debug command.

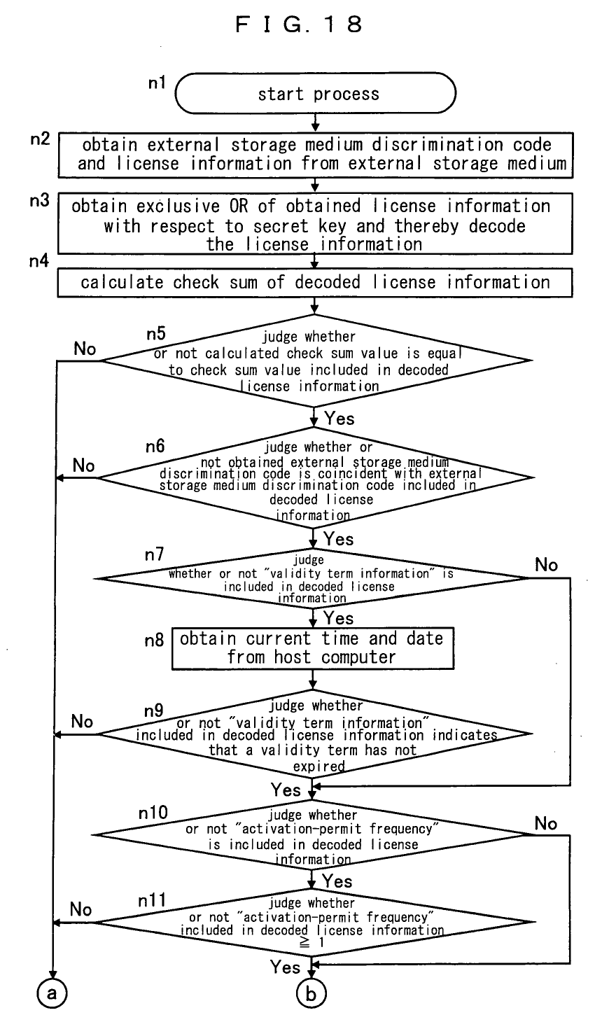

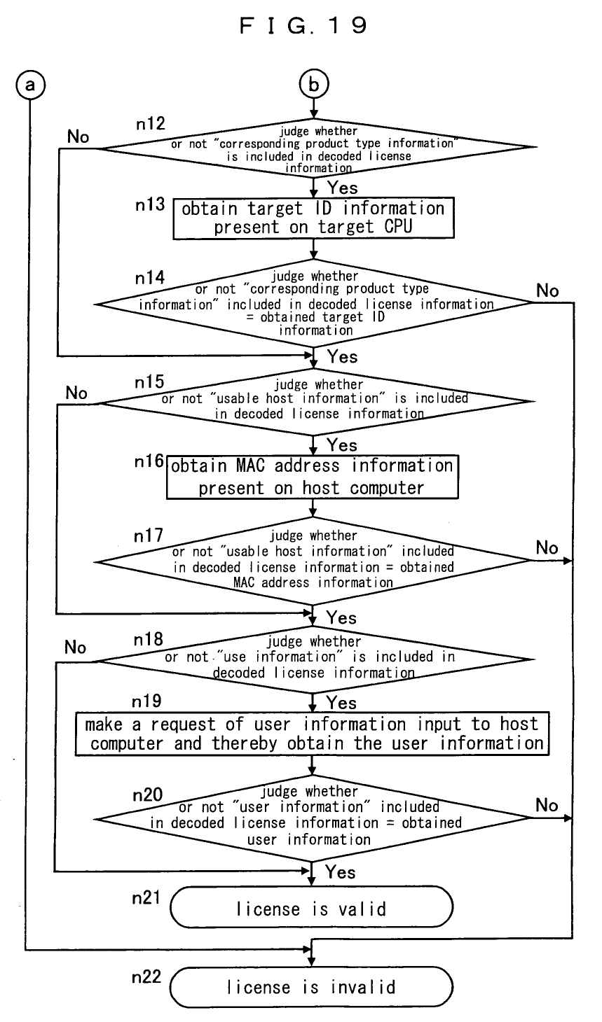

Next, an operation of a license information judging process executed by the debugging device A1 is described referring to flow charts of FIGS. 18 and 19.

More specifically, the license information judging process is executed by the control software 3 previously installed in the debugging device A1. When the user instructs the activation of the debugger 21, or inserts or extracts the external storage medium 6 with respect to the debugging device A1, Step n1 starts.

In Step n2, the external storage medium discrimination code 7 and the encrypted license information 8 are obtained from the external storage medium 6.

In Step n3, the license information is decoded in such a manner that an exclusive OR of the obtained license information 8 with respect to the secret key 4 is obtained.

In Step n4, a check sum value of the decoded license information is calculated.

In Step n5, it is judged whether or not the calculated check sum value is equal to the “check sum value” included in the decoded license information. The process advances to Step n22 when the values are not equal to each other, while advancing to Step n6 when they are equal to each other.

In the Step n6, it is judged whether or not the obtained external storage medium discrimination code is coincident with the “external storage medium discrimination code” included in the decoded license information. The process advances to the Step n22 when the codes are not coincident with each other, while advancing to Step n7 when they are coincident with each other.

In the Step n7, the presence/absence of the “validity term information” included in the decoded license information is judged. The process advances to Step n8 when the information is present, while advancing to Step n10 when the information is absent.

In the Step n8, a current time and date are obtained from the host computer 20.

In Step n9, the “validity term information included in the decoded license information is compared to the obtained current time and date. The process advances to the Step n10 when the validity term information indicates that a validity term has not expired, while advancing to Step N22 when the expiration of the validity term is confirmed and the license is thereby judged to be invalid.

In the Step n10, the presence/absence of the “activation-permit frequency” included in the decoded license information is judged. The process advances to Step n11 when the information is present, while advancing to Step n12 when the information is absent.

In the Step n11, it is judged whether or not the “activation-permit frequency” included in the decoded license information is at least “1”. The process advances to the Step n12 when the frequency is at least “1”, while advancing to the Step n22 when the frequency is below “1”.

In the Step n12, the presence/absence of the “corresponding product type information” included in the decoded license information is judged. The process advances to Step n13 when the information is present, while advancing to Step n15 when the information is absent.

In the Step n13, the target ID information 31 present on the target CPU 30 is obtained.

In Step n14, it is judged whether or not the obtained target ID information is coincident with the “corresponding product type information” included in the decoded license information. The process advances to the Step n15 when the informations are coincident with each other, while advancing to the Step n22 when they are not.

In the Step n15, the presence/absence of the “usable host information” included in the decoded license information is judged. The process advances to Step n16 when the information is present, while advancing to Step n18 when the information is absent.

In the Step n16, the Mac address information 22 present on the host computer 20 is obtained.

In Step n17, it is judged whether or not the obtained Mac address information is coincident with the “usable host information” included in the decoded license information. The process advances to the Step n18 when the informations are coincident wit each other, while advancing to the Step n22 when they are not.

In the Step n18, the presence/absence of the “user information” included in the decoded license information is judged. The process advances to Step n19 when the information is present, while advancing to Step n21 when the information is absent.

In the Step n19, the input of the user information is requested to the host computer 20, and the user information is thereby obtained. The input of the user information will be described in detail later.

In Step n20, it is judged whether or not the obtained user information is coincident with the “user information” included in the decoded license information. The process advances to the Step n21 when the informations are coincident with each other, while advancing to the Step n22 when they are not.

In the Step n21, the obtained license information is judged to be valid, and a license permit signal is outputted as the internal signal S7 shown in FIG. 2 to the host communication section 1. The host communication section 1 inputs the license permit signal S7 therein and outputs an activation permit signal as the debug data D4 to the debugger 21. The debugger 21 is activated in response to the reception of the activation permit signal D4 so that a window data for inputting a GUI data and debug command of the debugger is outputted to the display unit 24. The display unit 24 notifies the user of the successful activation of the debugger through the display of the GUI of the debugger.

In the Step n22, the obtained license information is judged to be invalid, and a license nonpermit signal is outputted as the internal signal S7 shown in FIG. 2 to the host communication section 1. The host communication section 1 inputs the license nonpermit signal S7 therein and outputs an activation nonpermit signal as the debug data D4 to the debugger 21. The debugger 21 is not activated when the activation nonpermit signal D4 is received, and the user is notified of a license error displayed on the display unit 24.

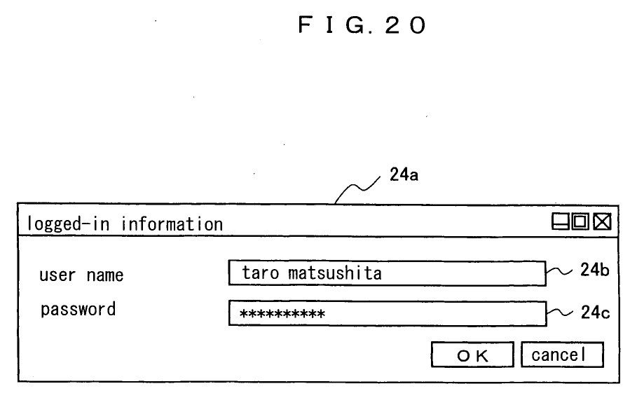

FIG. 20 shows a window display when the user information is inputted. When the user information is included in the license information 8, a user information input window 24a is displayed on the display unit 24 when the debugger is activated. The user inputs his/her user name to 24b and a password to 24c in the drawing so that he/she can be authenticated.

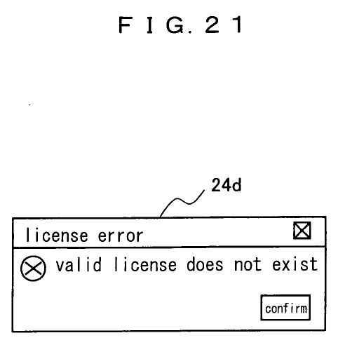

FIG. 21 shows an error display when the license is invalid. When the license judging process described referring to FIGS. 18 and 19 is failed at the time of the activation of the debugger, the debugger 21 displays an error message 24d on the display unit 24 to thereby control the activation of the debugger.

As described, when the license information judging process shown in FIGS. 18 and 19 is executed, the license is forcibly rendered invalid when the debugger is activated and when the external storage medium 6 is inserted or extracted with respect to the debugging device A1. Therefore, the license management of the debugger can attain a high security performance by using the discrimination code of the external storage medium 6, license information 8 and secret key 4.

Next is described a judgment made on the presence/absence of the valid license every time when the debugging device A1 receives the debug command D1 from the debugger 21.

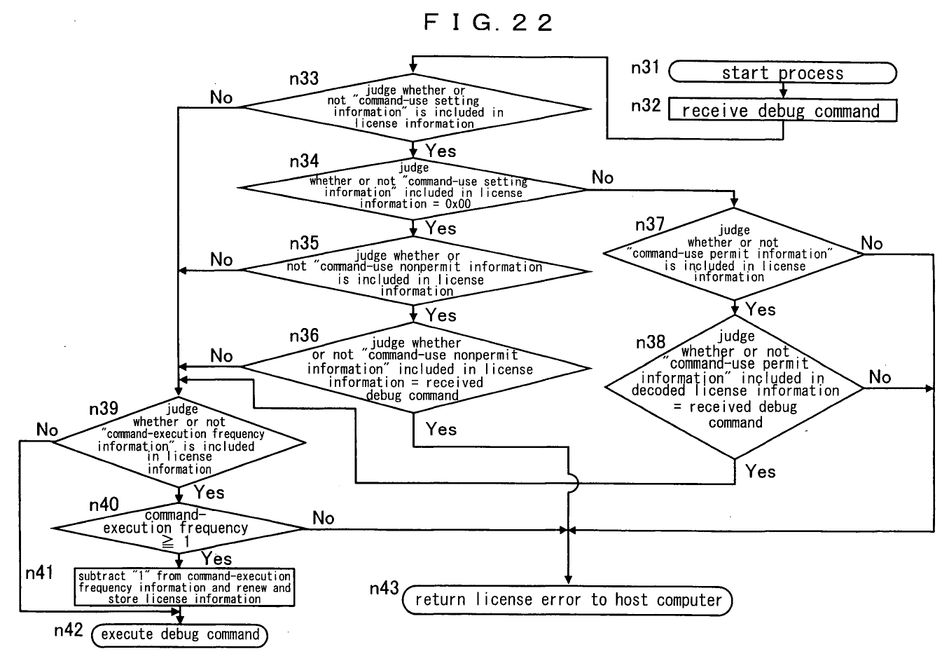

FIG. 22 is a flow chart of a license information judging process when the debug command is processed. The license information judging process is executed by the control software 3. When the debug command D1 is inputted to the debugging device A1, the control software 3 starts the execution of the process, and shifts the process to Step n31.

In Step n32, the received debug command is analyzed, and the process advances to Step n33.

In the step n33, it is judged whether or not the license information decoded in the Step n3 shown in FIGS. 18 and 19 includes the “command-use setting information” (see FIG. 10). The process advances to Step n34 when the information is included, while advancing to Step n39 when the information is not included.

In the Step n34, it is judged whether or not the numeral value “0x00” of the license information additional information 8b shown in FIG. 10 and the “command-use setting information” decoded in the Step n3 are coincident with each other. The process advances to Step n35 when the informations are coincident with each other, while advancing to Step n37 when they are not.

In the Step n37, the presence/absence of the “command-use permit information” included in the license information decoded in the Step n3 is judged. The process advances to Step n38 when the information is present, while advancing to Step n43 when the information is absent.

In the Step n38, it is judged whether or not the received debug command is included in the obtained command-use permit information. The debug command included therein is judged to be the permitted debug command, and the process then advances to Step n39. The debug command not included therein is judged to be the non-permitted debug command, and the process then advances to the Step n43.

In the Step n35, the presence/absence of the “command-use nonpermit information” included in the license information decoded in the Step n3 is judged. The process advances to Step n36 when the information is present, while advancing to the Step n39 when the information is absent.

In Step n36, it is judged whether or not the received debug command and the “command-use nonpermit information” included in the license information decoded in the Step n3 are coincident with each other. The process advances to the Step n43 when they the informations are coincident with each other, while advancing to the Step n39 when they are not.

In the Step n39, the presence/absence of the “command-execution frequency information” included in the license information decoded in the Step n3 is judged. The process advances to Step n40 when the information is present, while advancing to Step n42 when the information is absent.

In the Step n40, it is judged whether or not the obtained command-execution frequency is at least “1”. The process advances to Step n41 in the case of at least “1”, while advancing to Step n43 in the case of below “1”.

In the Step n41, “1” is subtracted from the obtained command-execution frequency information so that the command-execution frequency information is renewed. Then, the process advances to the Step n42.

In the Step n42, the debug command is executed. In the Step n43, the host computer is notified of the license error.

As thus far described, according to the first preferred embodiment, the debugging device A1 checks whether or not the valid license is present every time when the debug command is received. Then, the communication with the target CPU 30 to be debugged is commenced so that the debug command is executed only in the presence of the valid license, while the license error is transmitted to the host computer 20 in the absence of the valid license so that the execution of the debug command is completely prevented.

### Second Preferred Embodiment

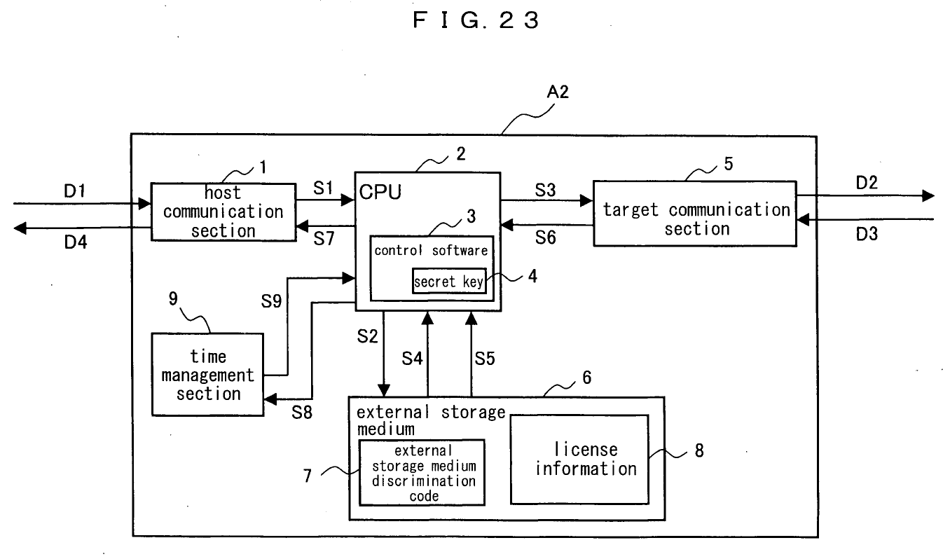

A second preferred embodiment of the present invention is described referring to FIGS. 23 through 25.

FIG. 23 is a block diagram illustrating a constitution of a debugging device A2 according to the second preferred embodiment. The debugging device A1 described in the first preferred embodiment further provided with a time management section 9 constitutes the debugging device A2. All of the components other than the time management section 9 are identical to those in the debugging device A1 according to the first preferred embodiment. The other identical components, which are shown in the example of FIG. 2, are provided with the same references and not described here again.

The time management section 9 is in charge of managing time and date and, for example, is likened to a clock whose operation is backed up by a battery. The time management section 9 is adapted to return a current time/date information S9 to the CPU 2 when a signal S8 for requesting the acquisition of the time and date is inputted thereto from the CPU 2. The host computer 20 is in charge of managing the time and date in the first preferred embodiment, however, the debugging device A2 is responsible for managing the time and date in the second preferred embodiment.

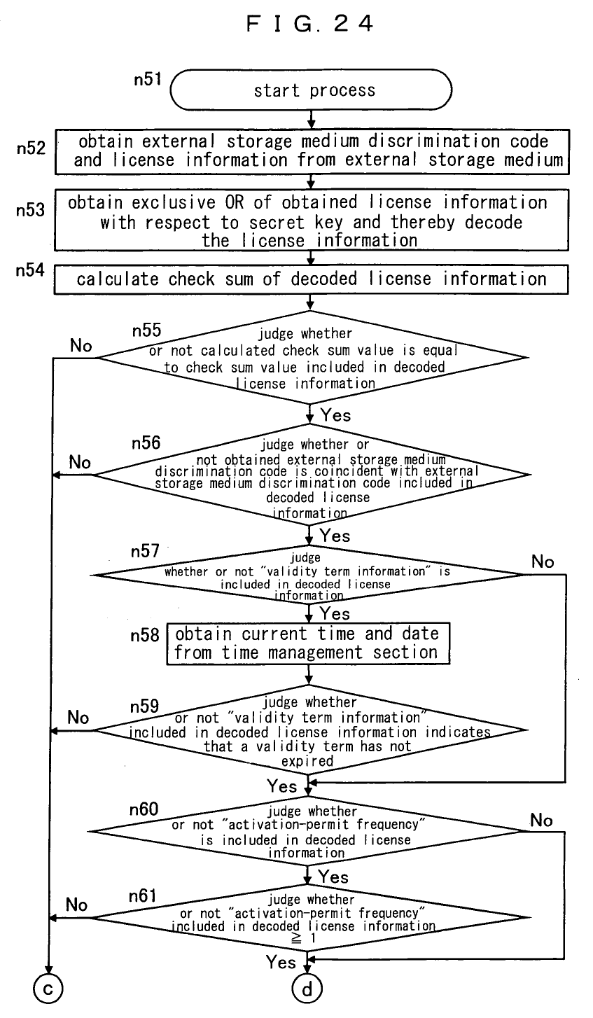

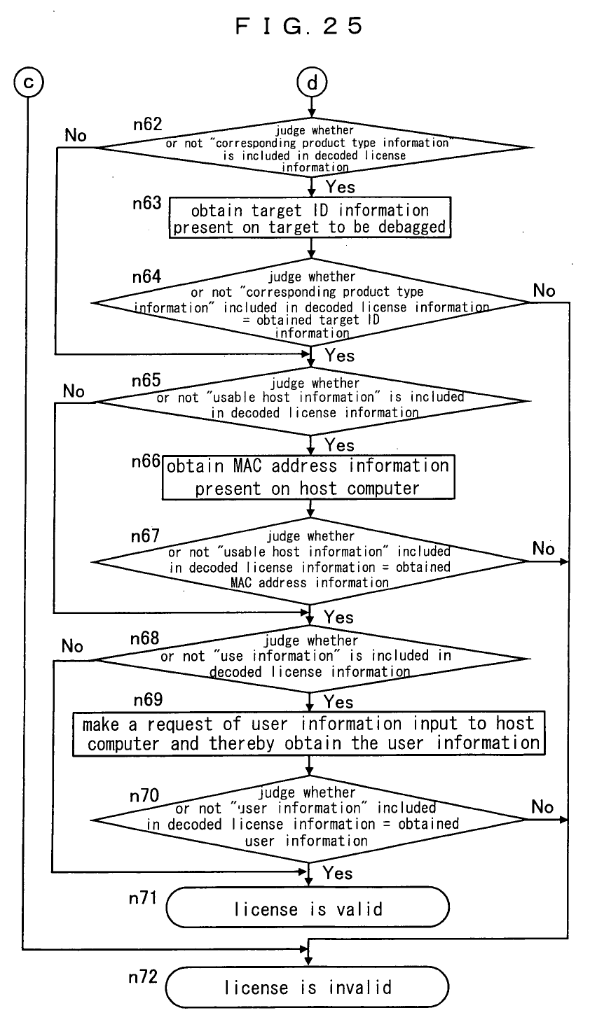

Next, an operation of a license information judging process executed by the debugging device A2 is described referring to flow charts of FIGS. 24 and 25.

The control software 3 shifts to Step n51 to start the process when the activation command from the debugger 21 is received or the external storage medium 6 is inserted or extracted with respect to the debugging device A2.

In Step n52, the external storage medium discrimination code 7 and the encrypted license information 8 are obtained from the external storage medium 6, and the process advances to Step n53.

In the Step n53, the obtained license information 8 is decoded in such a manner that the exclusive OR thereof with respect to the secret key 4 is obtained, and the process advances to Step n54.

In the Step n54, the check sum value of the decoded license information is calculated, and the process advances to Step n55.

In the Step n55, it is judged whether or not the calculated check sum value is equal to the “check sum value” included in the decoded license information. The process advances to Step n72, in which the license is judged to be invalid and the process is terminated, when they are not equal to each other, while advancing to n56 when they are equal to each other.

In the Step n56, it is judged whether or not the obtained external storage medium discrimination code is coincident with the “external storage medium discrimination code” included in the decoded license information. The process advances to the Step n72 when the informations are not coincident with each other, while advancing to Step n57 when they are coincident with each other.

In the Step n57, the presence/absence of the “validity term information” included in the decoded license information is judged. The process advances to Step n58 when the information is present, while advancing to Step n60 when the information is absent.

In the Step n58, the current time and date are obtained from the time management section 9, and the process advances to Step n59.

In the Step n59, the obtained current time and date are compared to the “validity term information” included in the decoded license information. The process advances to Step n60 when the validity term information indicates that the validity term has not expired, while advancing to the Step n72, in which the license is judged to be invalid and the process is terminated, when the expiration of the validity term is confirmed

In the Step n60, the presence/absence of the “activation-permit frequency information” included in the decoded license information is judged. The process advances to Step n61 when the information is present, while advancing to Step n62 when the information is absent.

In the Step n61, it is judged whether or not the “activation-permit frequency” included in the decoded license information is at least “1”. The process advances to the Step n62 in the case of at least “1”, while advancing to the Step n72, in which the license is judged to be invalid and the process is terminated, in the case of below “1”.

In the Step n62, the presence/absence of the “corresponding product type information” included in the decoded license information is judged. The process advances to Step n63 when the information is present, while advancing to Step n65 when the information is absent.

In the Step n63, the target ID information 31 present on the target CPU 30 is obtained, and the process advances to Step n64.

In the Step n64, it is judged whether or not the obtained target ID information is coincident with the “corresponding product type information” included in the decoded license information. The process advances to the Step n65 when the informations are coincident with each other, while advancing to the Step n72, in which the license is judged to be invalid and the process is terminated, when they are not coincident with each other.

In the Step n65, the presence/absence of the “host-use permit information” included in the decoded license information is judged. The process advances to Step n66 when the information is present, while advancing to Step n68 when the information is absent.

In the Step n66, the MAC address information 22 present on the host computer 20 is obtained, and the process advances to Step n67.

In the Step n67, it is judged whether or not the obtained MAC address information is coincident with the “usable host information” included in the decoded license information. The process advances to the Step n68 when the informations are coincident with each other, while advancing to the Step n72, in which the license is judged to be invalid and the process is terminated, when they are not.

In the Step n68, the presence/absence of the “use information” included in the decoded license information is judged. The process advances to Step n69 when the information is present, while advancing to Step n71 when the information is absent.

In the Step n69, the window when the user information is inputted, which is shown in FIG. 20, is displayed on the display unit 24, and the user is requested to input the user information so that the user information is obtained. When the input of the user information is completed, the process advances to Step n70.

In the Step n70, it is judged whether or not the obtained user information is coincident with the “user information” included in the decoded license information. The process advances to the Step n71 when the informations are coincident with each other, while advancing to the Step n72 when they are not.

In the Step n71, the license is judged to be valid, and a license permit signal S7 shown in FIG. 23 is outputted to the host communication section 1. When the license permit signal S7 is inputted, the host communication section outputs the debug data D4 (activation permit signal) to the debugger 21. The debugger 21 is activated in response to the reception of the activation permit signal D4, and outputs the window data for inputting the GUI data and debug command of the debugger to the display unit 24. The display unit 24 receives the window data for inputting the GUI data and debug command, and then displays the GUI of the debugger to thereby inform the user that the debugger has been normally activated.

In the Step n72, the license is judged to be invalid, and the license nonpermit signal S7 is outputted to the host communication section 1. When the license nonpermit signal S7 is inputted, the host communication section 1 outputs the debug data D4 (activation nonpermit signal) to the debugger 21. The debugger 21 is not activated when the activation nonpermit signal D4 is received, and displays the generation of the license error on the display unit 24 so that the user is informed.

As described, when the process shown in FIGS. 24 and 25 is executed, the license is forcibly rendered invalid when the debugger is activated and when the external storage medium 6 is inserted or extracted with respect to the debugging device A2. Therefore, the license management of the debugger can attain a high security performance by using the discrimination code of the external storage medium 6, license information 8 and secret key 4.

Further, the presence/absence of the valid license every time when the debugging device A2 receives the debug command from the debugger 21 can be judged when of the process described referring to FIG. 22 is executed.

As thus far described, according to the second preferred embodiment, the debugging device A2 checks whether or not the valid license is present every time when the debug command is received. Then, the communication with the target CPU 30 to be debugged is commenced so that the debug command is executed only in the presence of the valid license. Further, the host computer 20 is notified of the license error in the absence of the valid license so that the execution of the debug command is completely prevented. Further, the time management section 9 is provided in the debugging device A2 so that the current time and date are obtained. Then, it becomes unnecessary to obtain the current date and time from the host computer 20 in order to judge the validity term as described in the first preferred embodiment. Thereby, the management of the validity term of the debugger can be facilitated.

### Third Preferred Embodiment

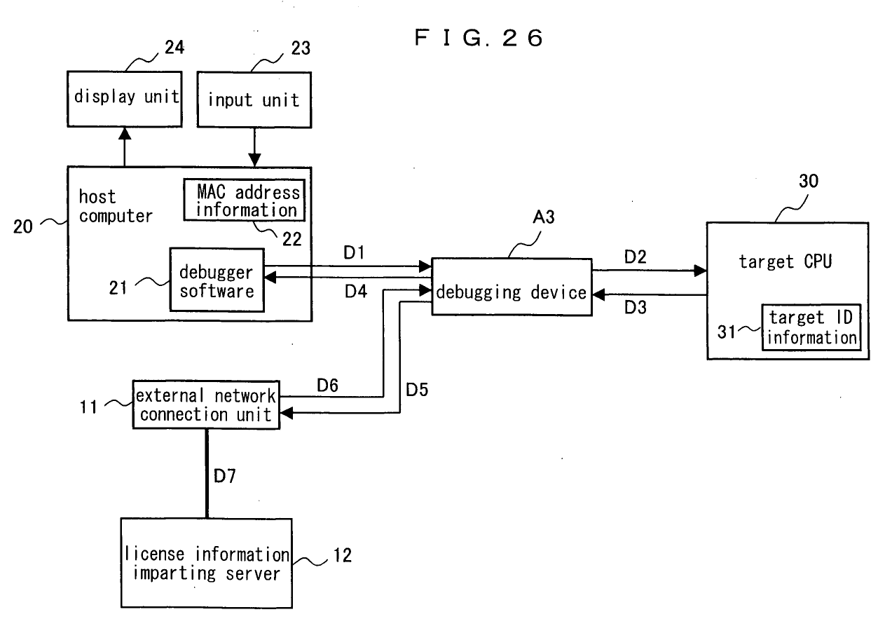

A third preferred embodiment of the present invention is described referring to FIGS. 26 through 31.

FIG. 26 is a block diagram illustrating a constitution of a debugging system according to the third preferred embodiment. In FIG. 26, the debugging system according to the third preferred embodiment is characterized in that an external network connection unit 11 and a license information imparting server 12 are further provided in the debugging system of FIG. 1 described in the first preferred embodiment. The external network connection unit 11 serves as a connecter for providing connection to an external network. The license information imparting sever 12 renews the license information for the user of the debugger. The external network connection unit 11 and the license information imparting server 12 are operated based on instructions from a debugging device A3. The renewal of the license information will be described in detail later.

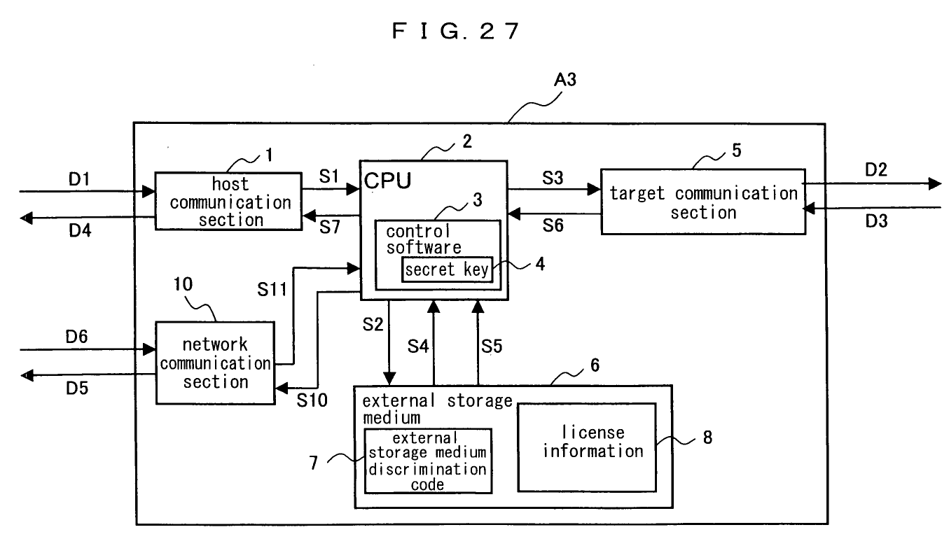

FIG. 27 is a block diagram illustrating a constitution of the debugging device A3 according to the third preferred embodiment. The debugging device A3 is characterized in that a network communication section 10 is further provided in the debugging device A1 of FIG. 2 described in the first preferred embodiment. The network communication section 10 outputs a license renewal information D5 to the external network connection unit 11 in response to the reception of a license renewal processing request S10 from the CPU 2.

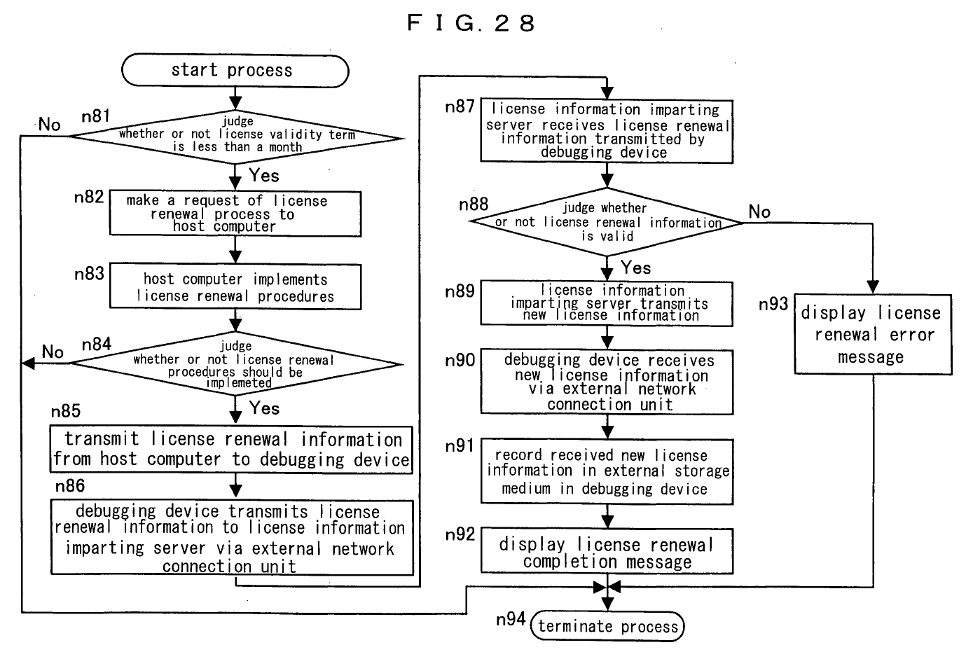

FIG. 28 is a flow chart of a license information renewal process in the debugging device A3. In the license information renewal process shown in FIG. 28, the control software 3 in the debugging device A3 constantly executes Step n81. When the remaining license term is less than a month, the process advances to Step n82, while advancing to Step n94 so that the process is terminated when the remaining license term is at least a month.

In the Step n82, the license renewal request is made to the host computer 20, and the process advances to Step n83.

In the Step n83, when the host computer 20 receives the request of the license renewal process from the debugging device A3, the host computer 20 displays a window for implementing license renewal procedures to the user, and the process advances to Step n84. The window for executing the license renewal procedures is shown in FIG. 29.

In FIG. 29, a window 24e for the license renewal is displayed on the display unit 24 of the host computer 20 when the Step n84 is executed. In the present example, a term for license extension and an object whose license is to be renewed are selected, and a payment method is designated. In the case of renewing the license information under the shown conditions, the license renewal operation starts when a lower-right “OK” button 24f is pressed, and the process advances to Step n85. When the license information is not renewed, a “cancel” button 24g shown in the drawing is pressed, and the process advances to the Step n94.

In the Step n85, a license renewal information is transmitted to the debugging device A3 from the host computer 20.

In Step n86, the debugging device A3 transmits a license renewal information D5 to the license information imparting server 12 via the external network connection unit 11, and the process advances to Step n87.

In the Step n87, the process advance to Step n88 when the license information imparting server 12 receives the license renewal information D5 transmitted by the debugging device A3.

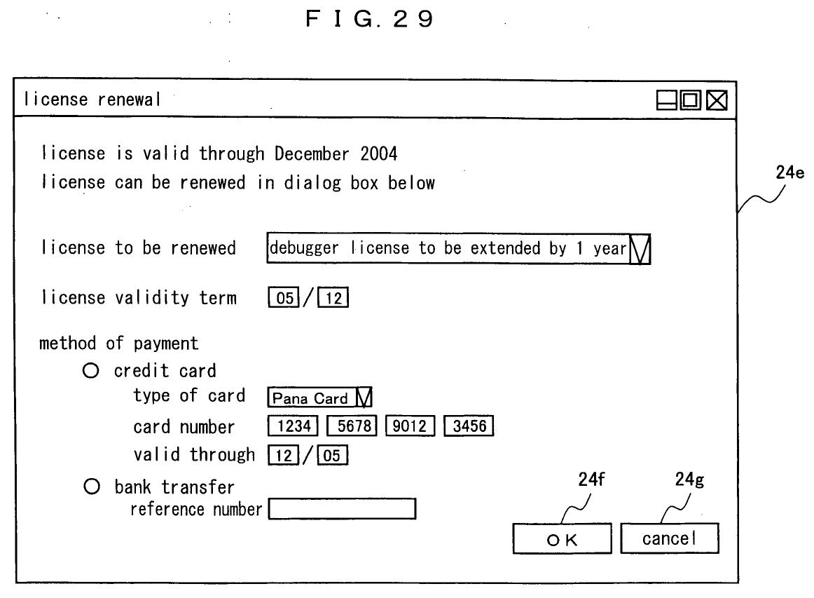

In the Step n88, it is judged whether or not the license renewal information is valid. The process advance to Step n89 when the information is valid, while advancing to Step n93, in which a license renewal error message 24h shown in FIG. 30 is displayed, when invalid. The user confirms the message 24h and presses a “confirmation button” 24i in the drawing, and the process advances to the Step n94 to be terminated.

In the Step n89, the license information imparting server 12 transmits a new license information D6 to the external network connection unit 11, and the process advances to Step n90.

When the debugging device A3 receives the new license information D6 from the external network connection unit 11 in the Step n90, the process advances to Step n91.

In the Step n91, the received new license information D6 is recorded on the external storage medium 6, and the process advances to Step n92.

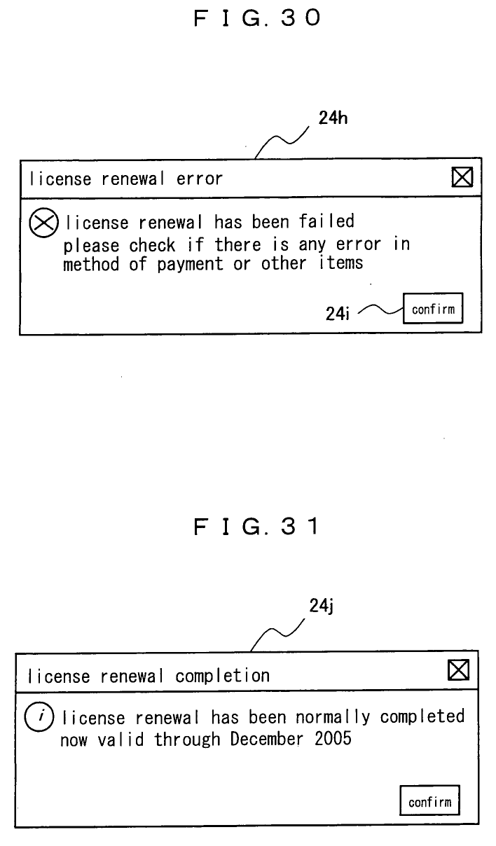

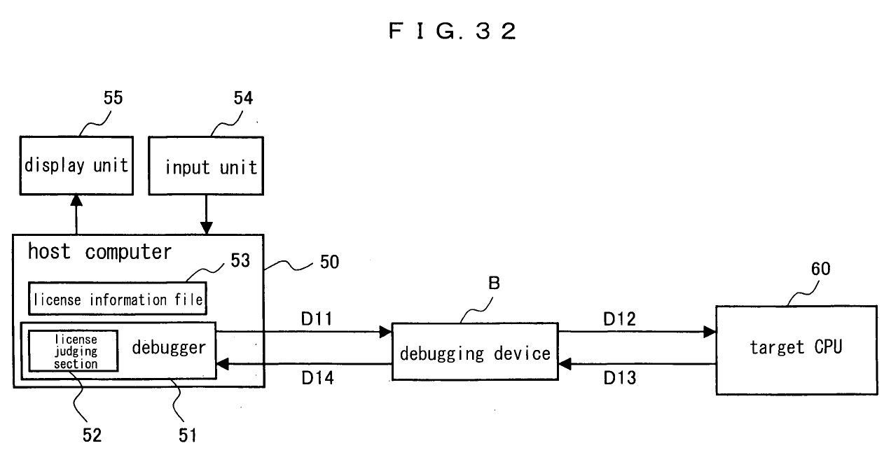

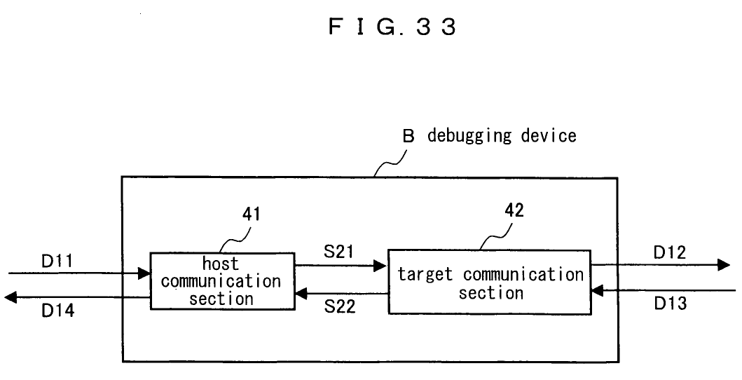

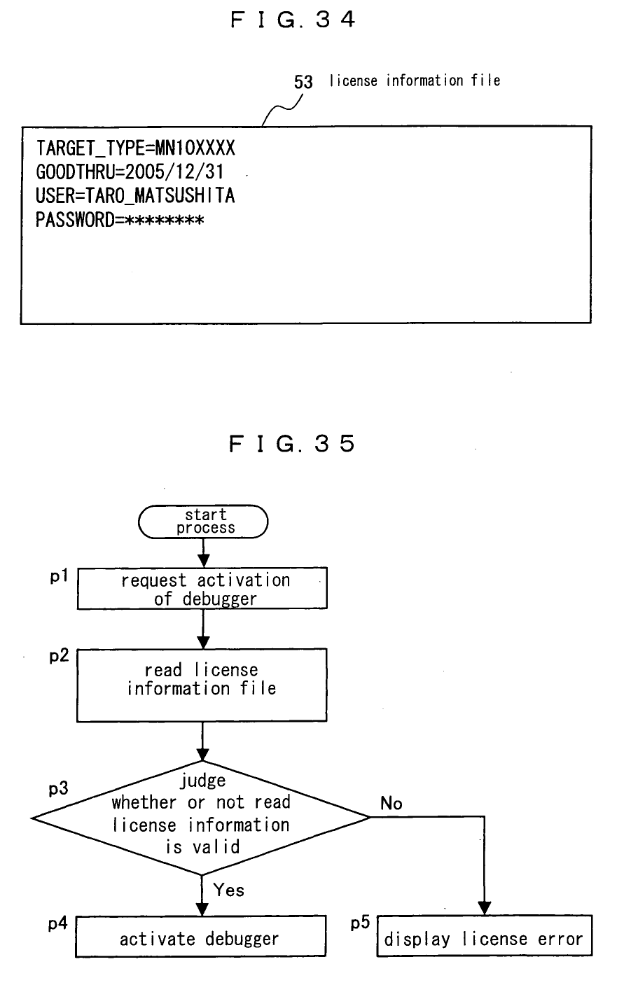

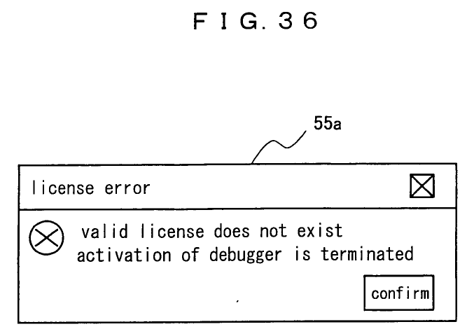

In the Step n92, a license renewal completion message 24j shown in FIG. 31 is displayed so that the user is informed that the license renewal process has been normally completed.

As thus far described, according to the third preferred embodiment, the external network connection unit 11 and the license information imparting server 12 are further provided in the debugging device A3 so that the license information from the license information imparting server 12 can be renewed via a network path D7 and the external network connection unit 11. As a result, burdens of the hassling renewal operation to be executed by the user can be lessened.

While the invention has been described and illustrated in detail, it is to be clearly understood that this is intended be way of illustration and example only and is not to be taken by way of limitation, the spirit and scope of this invention being limited only be the terms of the following claims.

What is claimed is:

1. A debugging device comprising:
a host communication section for transmitting and receiving data to and from a host computer;
a target communication section for transmitting and receiving data to and from a target CPU as an object to be debugged;
an external storage medium for storing a unique discrimination code for identifying the storage medium and an encrypted license information; and
a control section for decoding the license information using a predetermined secret key and judging whether or not the license information is valid using the discrimination code.

2. The debugging device as claimed in claim 1, further comprising a time management section for managing time and date.

3. The debugging device as claimed in claim 1, further comprising a network section for transmitting and receiving data to and from an external network line.

4. The debugging device as claimed in claim 1, wherein
the target CPU comprises a unique discrimination code for identifying a product type of the target.

5. The debugging device as claimed in claim 1, wherein
the license information includes a license validity term information indicating a term during which a debugger and the debugging device can be used.

6. The debugging device as claimed in claim 1, wherein
the license information includes an activation-permit frequency information indicating number of times when a debugger is permitted to be activated.

7. The debugging device as claimed in claim 1, wherein
the license information includes a command-use setting information indicating presence or absence of limitations in using a debug command.

8. The debugging device as claimed in claim 1, wherein
the license information includes a command-use permit information indicating a debug command which is permitted to be used.

9. The debugging device as claimed in claim 1, wherein
the license information includes a command-use nonpermit information indicating a debug command which is not permitted to be used.

10. The debugging device as claimed in claim 1, wherein
the license information includes a corresponding product type information indicating a product type of the CPU that can be debugged by a debugger.

11. The debugging device as claimed in claim 1, wherein
the license information includes a unique user ID information for identifying a user.

12. The debugging device as claimed in claim 1, wherein
the license information includes a unique host-use permit information for identifying the host computer permitted to be connected to the debugging device.

13. The debugging device as claimed in claim 1, wherein
the license information includes a command-execution frequency information indicating number of times when a debug command can be executed.
